(19) United States
(12) Patent Application Publication
(10) Pub. No.: US 2018/0350482 A1
(43) Pub. Date: Dec. 6, 2018

(54) Gamma Voltaic Cell

(71) Applicant: Michael Doyle Ryan, (US)

(72) Inventor: Michael Doyle Ryan, (US)

(21) Appl. No.: 15/613,759

(22) Filed: Jun. 5, 2017

(51) Int. Cl. G21H 1/04

(52) U.S. Cl. CPC G21H 1/04; G21Y 2004/60

(57) ABSTRACT

The Gamma Voltaic Cell is designed to capture the energy of gamma rays emitted from spent nuclear fuel rods and directly convert it to electric power, much the same as a photovoltaic cell converts sunlight to electricity. The cell takes advantage of Compton scattering and the different probability of interaction between dense metals and light metals for electrons and energetic photons. The cell uses multiple alternating layers of a dense metal and light metal separated by a mesh of non-conducting material such as fiberglass. The gamma ray interacts with the dense metal to free a recoil electron (to be captured by the light metal) and a somewhat lower energy photon that still usually would pass through the light metal layer. This lower energy photon can again undergo Compton scattering in the dense metal layer, until it is finally absorbed by the photoelectric effect. The excess electrons on the light metal layer can be connected to an external load and another wire to lead them back to the dense metal layer.

### BACKGROUND OF INVENTION

In the operation of a nuclear power plant, fuel rods need to be removed once the fission products build up to the point that they keep the nuclear reaction from continuing. Because they are still producing high levels of radiation, they must be kept away from people and the environment. Right now, the only concern is containing the rods as waste, not in trying to harness the considerable energy they are emitting.

### BRIEF SUMMARY OF INVENTION

The Gamma Voltaic Cell is designed to produce electricity with no moving parts, and to be fully submersible so that it can placed over spent nuclear fuel rods when they are storage pools after being removed from the nuclear reactor. The working part of the cell consists of alternating layers of a dense metal such as lead or tungsten and a light metal like aluminum with a spacer of a mesh of non-conducting material such as fiberglass screening between the metal layers, coiled up into a waterproof sheath with a wire connected to each layer leading to the external electric load.

### DESCRIPTION OF DRAWINGS: (NOT TO SCALE)

FIG. 1: Cross section of the orientation of the four layer sheet layers in relation to the source of the gamma rays

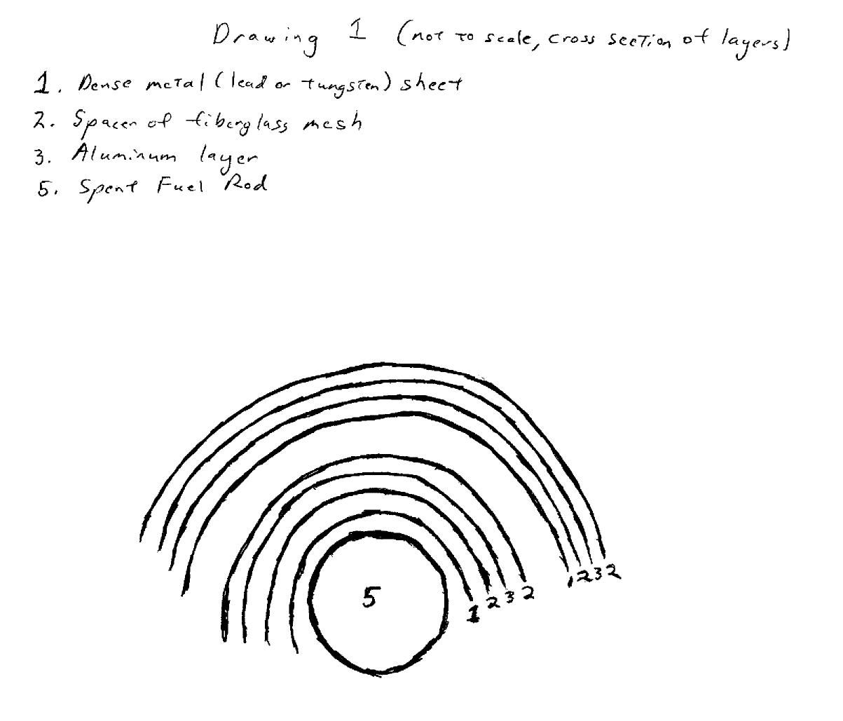

FIG. 2: Cross section of cell showing how coiling of the four layer sheet creates multiple chances for gamma rays to drive electrons from the lead to the aluminum layer.

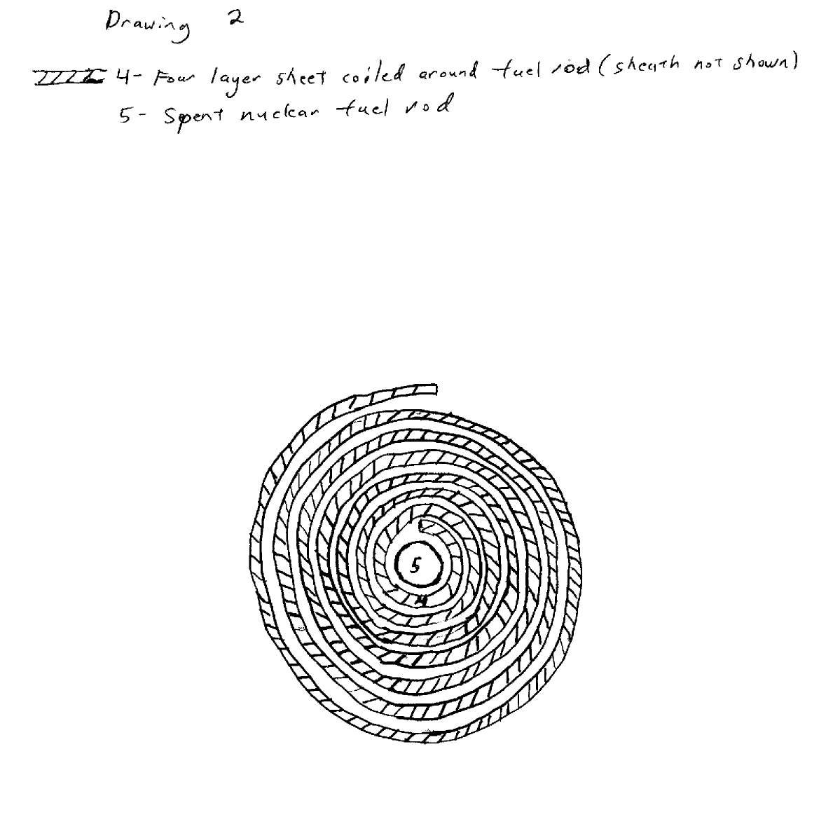

FIG. 3: Schematic of the interaction of gamma rays with the cell. The first three interactions produce Compton scattering, in the last one the gamma photon is finally fully absorbed by the photoelectric effect.

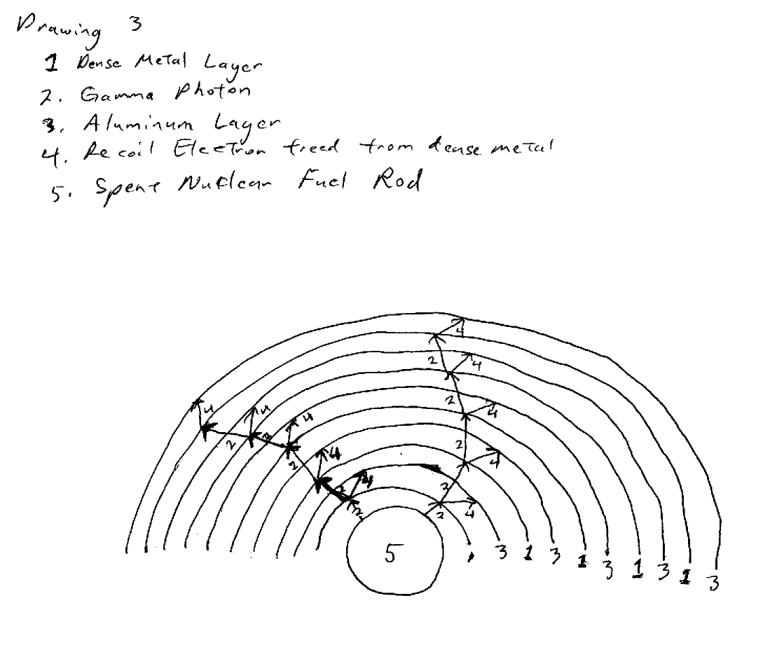

FIG. 4: Aluminum sheet showing grid of wires fused to the back side of a sheet of foil

FIG. 5: Outside view of cell, spent fuel rod, and wires to external load.

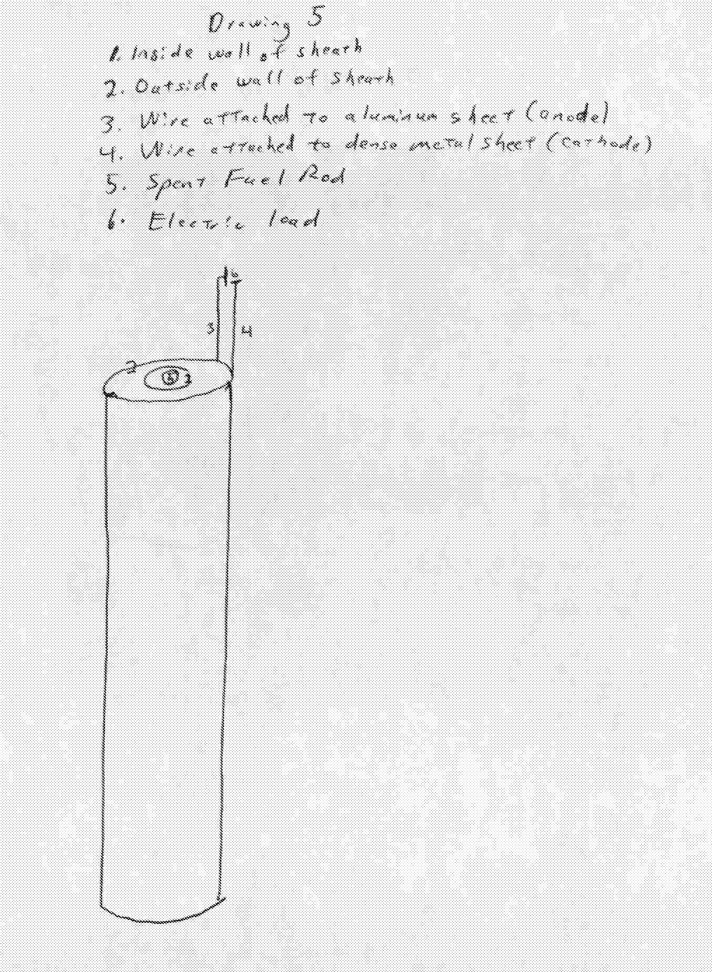

### DETAILED DESCRIPTION OF CELL

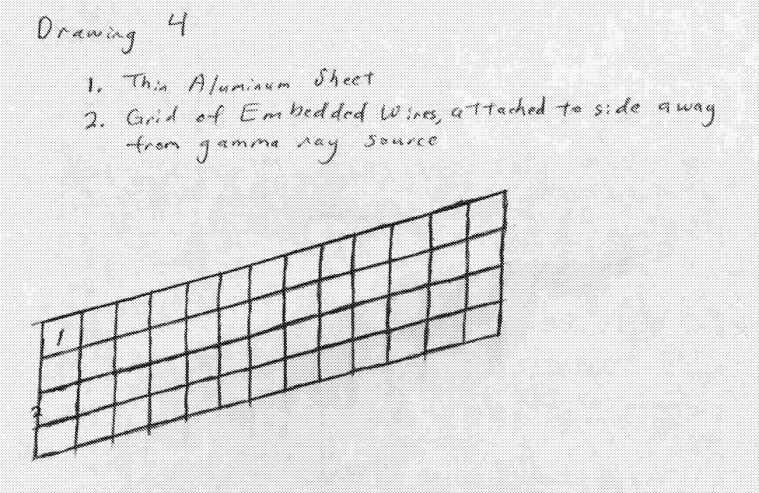

The cell consists of: 1. a sheath made of two cylinders of glass or plastic such as the smaller inner cylinder fits over a spent fuel rod, and two flat washer-shaped pieces to serve as the top and bottom end caps. 2. A four layer sheet coiled into the space between the two cylinders, which has a sheet of lead or tungsten, then a spacer layer of fiberglass mesh, a sheet of aluminum modified as shown in FIG. 4 to increase electron conduction, and another spacer layer of fiberglass mesh. 3. One wire attached to each metal layer and connected to an external electric load. In order to increase the conductance of the aluminum layer while limiting its own Compton scattering (which would drive some electrons from the aluminum layer back to the dense metal layer), a grid of wires would be fused to the aluminum sheet so that less mass is interposed by it between the dense metal layers. A vacuum would be created inside the cell to allow electrons freer passage from the dense metal layer to the aluminum layer. Once the cell is placed over the spent fuel rod, as shown in figure three, gamma rays first encounter the dense metal layer, where they can undergo Compton scattering, which ejects an electron from this layer (to be picked up by the aluminum layer since A is a charged particle) and scatters a photon of somewhat reduced energy and mostly of a small angle from the original photon, which would still usually have enough energy to make it through the light metal layer to interact again through Compton scattering with the next dense metal layer in its path, until it finally is absorbed through the photoelectric effect. This would lead to a build-up of excess electrons of the aluminum layer, which would take the path of least resistance to try to neutralize the imbalance by moving through the wire to do work before returning to the dense metal layer.

1. The Gamma Voltaic Cell takes advantage of Compton scattering a gamma rays to produce electromotive force from spent nuclear fuel rods by taking advantage of the different probabilities of interaction between a photon and a moving electron in a dense vs. a light metal.

2. By interposing multiple alternating layers of dense and light metal that encircle the path of gamma rays, there are multiple opportunities for the production of an excess of charge on the aluminum layer from the same incident photon.

3. By coiling the four-layer sheet inside the sheath of the cell, it makes the production of a single anode an single cathode easier and cheaper.

4. By fusing a grid of aluminum wires to one side of the aluminum sheet, it greatly increases the conductance of it while not increasing the mass of aluminum in the path of the gamma photons nearly as much, so that unwanted Compton Scattering in the light metal layer is minimized, increasing the efficiency of the cell.
